(19) United States
(12) Patent Application Publication
(10) Pub. No.: US 2025/0354027 A1
(43) Pub. Date: Nov. 20, 2025

(54) INK JET PRIMER APPLIED ON A CORRUGATOR

(71) Applicant: Electronics for Imaging, Inc., Londonderry, NH (US)

(72) Inventors: Mark Smith, Brownstown TWP, MI (US); Joshua Samuel, Ann Arbor, MI (US); Elizabeth Logue, Scituate, MA (US); Brittany Phelps, Flat Rock, MI (US); Frank Bruck, Dundee, MI (US)

(21) Appl. No.: 19/081,583

(22) Filed: Mar. 17, 2025

Related U.S. Application Data
(60) Provisional application No. 63/648,256, filed on May 16, 2024.

(51) Int. Cl. C09D 11/54; C09D 11/107; C09D 11/108; C09D 11/30; D21G 3/00; D21H 19/58; D21H 19/82; D21H 23/56

(52) U.S. Cl. CPC C09D 11/54; C09D 11/107; C09D 11/108; C09D 11/30; D21G 3/00; D21H 19/58; D21H 19/82; D21H 23/56

(57) ABSTRACT

A UV ink jet receptive primer is applied by a corrugator to produce a UV ink jet printable, continuous folded, corrugated material, e.g. fan fold. Priming is performed in-line by the corrugator. The primer should withstand the heat, humidity, and abrasion of the corrugator, yielding a surface that can be printed with UV inkjet ink and resulting in a high quality image.

### CROSS-REFERENCE TO RELATED APPLICATIONS

This application claims priority to provisional patent application Ser. No. 63/648,256, filed May 16, 2024, which application is incorporated herein in its entirety by this reference thereto.

### TECHNICAL FIELD

Various of the disclosed embodiments concern a UV ink jet receptive primer applied on a corrugator.

### BACKGROUND

UV Inkjet printing on paper based corrugated substrates requires primers to attain good quality when printed with UV inkjet inks. Corrugated inkjet printing is normally a sheet-fed operation, and the sheets are primed in-line using an analogue coating system such as a flexographic station or a roller-coater.

Continuous corrugated material that is folded, referred to as fan fold material, is required for in-line automated processing downstream.

Fan fold material cannot be analogue primed because of the folds, which cause coating flaws. There is a need to pre-prime the liner that is then corrugated and formed into a fan fold configuration.

### SUMMARY

A UV ink jet receptive primer is applied by a corrugator to produce a UV ink jet printable, continuous folded, corrugated material, e.g. fan fold. Priming is performed in-line by the corrugator. The primer is designed to withstand the heat, humidity, and abrasion of the corrugator, yielding a surface that can be printed with UV inkjet ink and resulting in a high quality image.

Embodiments of the invention enable paper to be primed in the manufacturing process, repurposing the print station on a corrugator as a priming unit. This primer readies the fan fold paper for a UV ink jet print. The primer enhances the quality of the print by controlling the dot spread and the absorption of the ink or components of ink into the paper liner. For commonly used clay coated boards, with representative boards such as Metsa Pro (https://www.metsagroup.com/metsaboard/products-and-services/products/white-kraftliners/metsaboard-pro-wkl/) or Metsa Classic (https://www.metsagroup.com/metsaboard/products-and-services/products/white-kraftliners/metsaboard-classic-wkl/) the primer increases dot gain relative to unprimed boards to attain smooth and uniform solid prints.

There is currently no other method to prepare the fan fold for inkjet printing.

### BRIEF DESCRIPTION OF THE DRAWINGS

FIG. 1 is a schematic representation of a corrugator in which primer is applied in line according to an embodiment of the invention; and

FIG. 2 is a partial detailed schematic representation of the corrugator of FIG. 1 according to an embodiment of the invention.

### DETAILED DESCRIPTION

The herein disclosed invention uniquely provides a method and apparatus that primes fan fold corrugated media for ink jet printing. One technical challenge of pre-priming such media for UV inkjet inks before corrugation and fan fold of the media is performed is the requirement that the surface quality and uniformity of surface energy is maintained through the harsh conditions of the corrugator where there are temperatures exceeding 135° C., steam, and abrasion. An example of a corrugator is found at the following link: https://www.bhs-world.com/en/corrugators/corrugator-lines.

Priming can be done offline with subsequent corrugation but preferably it is done in-line with a coating station going directly to the corrugator. In-line coating is preferred because there are fewer logistics and paper roll movements required, making it more cost effective. In both the in-line and offline case the primer must withstand the harsh conditions of the corrugator as described above.

Embodiments of the invention provide a method and apparatus with which a primer that is applied in-line in a corrugator and feeds directly from the primer application station into the corrugator. This primed top layer is then the printable portion of the fan fold that exits the corrugator. A representative primer formulation is composed of acrylic colloidal polymer from 5-20%, crosslinking styrenated acrylic emulsion from 10-30%, styrene butadiene polymer from 20-50%, inorganic filler from 0-6%, polymeric wax from 10-15%, additional commonly used additives such as defoamers, pH adjusters, and biocide from 2-3%, and the balance of the formula is deionized water.

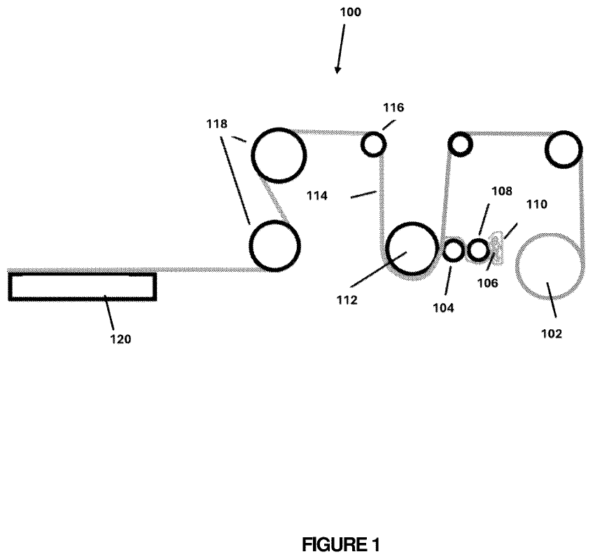

FIG. 1 is a schematic representation of a corrugator 100 in which primer is applied in-line according to an embodiment of the invention. In FIG. 1, the top liner 102 is coated with the primer 106 when it comes into contact with the application roller 104. A doctor chamber 110 controls the amount of primer applied to the liner. The primer application station may be any commonly used coating station such as an anilox coater 108 or a roll coater. The coating station is a common feature on corrugators where it is often used to apply a single ink color before corrugation such as Staples red. In embodiments of the invention, printing plates are not required because ink application is full coverage. The priming station may optionally include a dryer.

The primed top-layer 114 is transported past a central impression cylinder 112, which supports the liner while applying primer, and an idler roller 116, which guides the liner, before it is conditioned on the triple stack steam drums 118. The triple stack steam drums prepare the liner for glueing and the joining of the fluting medium layer of the corrugated construction. Conditioning on the triple stack steam drums allows the starch glue to adhere to the liner which is applied just before it enters the double backer 120. In the double backer the primed layer contacts heating plates under pressure from a ballast belt above, forming the corrugated structure. The primer layer can undergo abrasion in the double backer.

The primer as described above should enable good quality UV inkjet printing with good dot spread of the UV inkjet drops so that images form uniformly and consistently but spread is not excessive so that character definition is retained. In addition, the primer must exhibit good overall adhesion of the system. The primer must adhere well to the paper and the ink to the primer, otherwise the printed image may easily flake or scrape off.

The primer must be resistant to temperatures up to 135° C. and abrasion in the corrugator, and must dry fast enough so that it is formed when it reaches the area of the corrugator where it experiences steam and abrasion. The primer must not soften and sink into the paper under the high temperature of the corrugator and have sufficient hardness so that it is not abraded where the corrugation is formed under pressure in the double backer. Conversely, the primer cannot be so hard and chemically crosslinked that it becomes brittle, and its adhesion is compromised.

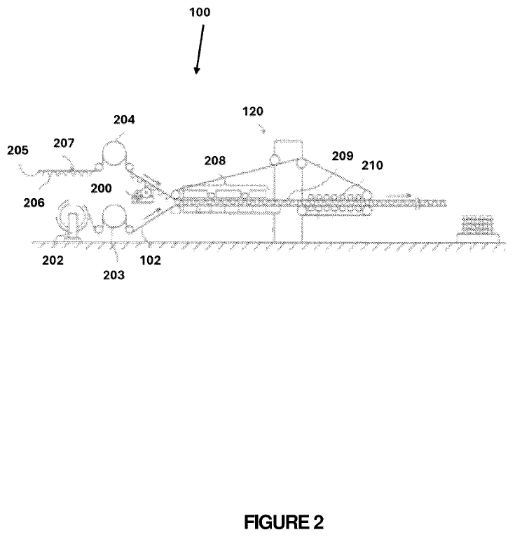

FIG. 2 is a partial detailed schematic representation of the corrugator of FIG. 1 according to an embodiment of the invention. The coating device 108 (FIG. 1) is an existing part of the corrugator as it is generally used for single color flexo ink printing processes on the top layer of the corrugate. In contrast to the state of the art, embodiments of the invention use a full coverage coat versus the use of a printing plate to reverse print a single color image.

In FIG. 2, a bottom linerboard 205 and corrugated medium 206 comprise a single-face corrugated fiberboard 207. The top liner 102 is primed after the mill roll stand 202 and before the preheater 203. The gluing device 200 is shown in FIG. 2 along with the double backer 120 that includes heat plates 208 which are used to combine the top liner to glued fluting medium and bottom liner. In FIG. 2, preheaters 203 and 204 are comparable to steam drums 118 in FIG. 1. The completed sheet 209 is then transported from the corrugator via a roller group 210. Thereafter, the primed corrugated sheets may be printed, cut, and folded as desired.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

I/we claim:

1. A method for processing fan fold corrugated media in a corrugator for ink jet printing, comprising:
applying a primer to a top liner of a fan fold corrugated media in-line at a primer application station in said corrugator, said primer comprising:
acrylic colloidal polymer from 5-20%, crosslinking styrenated acrylic emulsion from 10-30%, styrene butadiene polymer from 20-50%, inorganic filler from 0-6%, polymeric wax from 10-15%, additional additives comprising any of defoamers, pH adjusters, and biocide from 2-3%, and a balance of the formula comprising deionized water; and
feeding said primed top liner from the primer application station toward a double backer within said corrugator;
wherein the primed top layer comprises a printable portion of the fan fold that exits the corrugator.

2. A corrugator, comprising:
at an application station in-line in the corrugator, a roller configured to apply a full coverage coat of said primer to said top liner;
a central impression cylinder configured to support the top liner while said primer is applied thereto by the roller;
an idler roller configured to guide the top liner;
triple stack steam drums configured to prepare the liner for glueing and joining of a fluting medium layer of a corrugated construction; and
a double backer in which the primed top liner contacts heating plates under pressure from a ballast belt to form the corrugated structure.

3. The corrugator of claim 2, wherein a doctor chamber controls the amount of primer applied to the top liner.

4. The corrugator of claim 2, wherein said roller comprises any of a an anilox coater or a roll coater.

5. The corrugator of claim 2, wherein said application station further comprises a dryer.

6. The corrugator of claim 2, wherein the primer is resistant to temperatures up to 135° C. and abrasion in the corrugator;
wherein the primer dries fast enough so that it is formed when it reaches an area of the corrugator where it experiences steam and abrasion;
wherein the primer does not soften and sink into the top liner under the high temperature of the corrugator;
wherein the primer has sufficient hardness so that it is not abraded where the corrugation is formed under pressure in the double backer; and
wherein the primer is not so hard and chemically crosslinked that it becomes brittle, and its adhesion is compromised.

7. The corrugator of claim 6, wherein said primer comprises:
acrylic colloidal polymer from 5-20%, crosslinking styrenated acrylic emulsion from 10-30%, styrene butadiene polymer from 20-50%, inorganic filler from 0-6%, polymeric wax from 10-15%, additional additives comprising any of defoamers, pH adjusters, and biocide from 2-3%, and a balance of the formula comprising deionized water.

8. A primer for application to fan fold corrugated media in a corrugator for ink jet printing, said primer comprising:
acrylic colloidal polymer from 5-20%, crosslinking styrenated acrylic emulsion from 10-30%, styrene butadiene polymer from 20-50%, inorganic filler from 0-6%, polymeric wax from 10-15%, additional additives comprising any of defoamers, pH adjusters, and biocide from 2-3%, and a balance of the formula comprising deionized water.
